(19) United States
(12) Patent Application Publication
(10) Pub. No.: US 2019/0325318 A1
(43) Pub. Date: Oct. 24, 2019

(54) METHOD AND SYSTEM FOR LEARNING IN A TRUSTLESS ENVIRONMENT

(71) Applicant: ANTS TECHNOLOGY (HK) LIMITED, HONG KONG (HK)

(72) Inventors: Ron FRIDENTAL, Shoham (IL); Oranit DROR, Rishon LeZion (IL); ldit DIAMANT, Raanana (IL)

(21) Appl. No.: 15/955,711

(22) Filed: Apr. 18, 2018

(51) Int. Cl. G06N 3/08; G06F 21/60; G06T 7/00; G06F 15/18; G06K 9/62

(52) U.S. Cl. CPC G06N 3/088; G06F 21/60; G06T 2207/20081; G06F 15/18; G06K 9/6262; G06T 7/0002

(57) ABSTRACT

A system and method for training a learner based on private data, the method including receiving by a processor private unannotated data from a private unannotated dataset, the private unannotated data is inaccessible for annotation from outside the processor or by a user interface of the processor and training a learner engine based on the received private data.

### BACKGROUND

Known image and video processing tools usually utilize static image frames for analysis of the image, comparison, identification of objects and manipulation of the image data. Such tools, when they use machine learning techniques, usually apply pre-trained neural networks trained to identify specific types of objects defined in advance. Therefore, such systems are very limited and inflexible.

Regularly, neural network analysis requires a large amount of pre-tagged data, as training material. In case there is not enough data, or tagging is impossible for some reason, the training of the neural network will be flawed.

### REFERENCES

[1] Jacob Goldberger and Ehud Ben-Reuven. Training deep neural networks using a noise adaptation layer. ICLR, 2017.

[2] Eran Malach and Shai Shalev-Shwartz. Decoupling “when to update” from “how to update”. 31st Conference on Neural Information Processing Systems (NIPS 2017).

[3] Tsung-Yi et al. Microsoft COCO: Common Objects in Context. arXiv:1405.0312v3 [cs.CV] 21 February 2015.

[4] The PASCAL Visual Object Classes Challenge: A Retrospective Everingham, M., Eslami, S. M. A., Van Gool, L., Williams, C. K. I., Winn, J. and Zisserman, A. International Journal of Computer Vision, 111(1), 98-136, 2015

[5] PIROPO Database (2016): People in Indoor ROoms with Perspective and Omnidirectional cameras. The PIROPO database (People in Indoor ROoms with Perspective and Omnidirectional cameras) comprises multiple sequences recorded in two different indoor rooms, using both omnidirectional and perspective cameras. The sequences contain people in a variety of situations, including people walking, standing, and sitting. Both annotated and non-annotated sequences are provided, where ground truth is point-based (each person in the scene is represented by the point located in the center of its head). In total, more than 100,000 annotated frames are available.

### SUMMARY

An aspect of some embodiments of the present disclosure provides a method for training a learner based on private data, the method comprising receiving by a processor private unannotated data from a private unannotated dataset, the private unannotated data is inaccessible by a user interface of the processor; and training a learner engine based on the received private data.

Optionally, the method comprising inferring attributes to the received private unannotated data, and updating the learner engine based on the inferred attributes.

Optionally, the inferring is by the learner engine.

Optionally, the inferring is by at least one other learner engine.

Optionally, the method comprising repeating the receiving of private unannotated data, inferring, and updating.

Optionally, the method comprising correcting, neutralizing or reducing the effect of inaccurate inferred attributes.

Optionally, the method comprising, before receiving of private unannotated data, receiving private annotated data and updating the learner engine based on the received private annotated data, wherein the received private annotated data is inaccessible by the user interface of the processor.

Optionally, the repealing includes repeating the receiving of the private annotated data and updating the learner engine based on the received private annotated data.

Optionally, the method comprising, before receiving of private unannotated data, receiving public annotated data and updating the learner engine based on the received public annotated data.

Optionally, the repeating includes repeating the receiving of the public annotated data and updating the learner engine based on the received public annotated data.

Optionally, the private unannotated data is received from a private data capturing device inaccessible for viewing or annotation of data by the user interface of the processor.

Optionally, the private annotated data is received from a private computer inaccessible for viewing or annotation of data by the user interface of the processor.

Optionally, the method comprising estimating, by the processor, the potential noise generated in the inference of annotations, and determining, based on the estimation, the amount of new private unannotated data and corresponding inferred annotations that should be acquired.

Optionally, the method comprising generating synthesized image data and training the learner engine based on the synthesized image data.

An aspect of some embodiments of the present disclosure provides a system for training a learner based on private data, the system comprising: a processor; a user interface for communicating with the processor, and a private dataset inaccessible for viewing or annotation of data by the user interface of the processor, wherein the processor is configured to execute code instructions that cause the processor to: receive private unannotated data from the private dataset, the private unannotated data is inaccessible by the user interface of the processor; and train a learner engine based on the received private data.

Optionally, the code instructions cause the processor to infer attributes to the received private unannotated data, and to update the learner engine based on the inferred attributes.

Optionally, the inferring is by the learner engine.

Optionally, the interring is by at least one other learner engine.

Optionally, the method comprising repeating the receiving of private unannotated data, inferring, and updating.

Optionally, the method comprising correcting, neutralizing or reducing the effect of inaccurate inferred attributes.

Optionally, the code instructions cause the processor to estimate the potential noise generated in the inference of annotations, and determine, based on the estimation, the amount of new private unannotated data and corresponding inferred annotations that should be acquired.

### BRIEF DESCRIPTION OF THE DRAWINGS

Some non-limiting exemplary embodiments or features of the disclosed subject matter are illustrated in the following drawings.

In the drawings:

FIG. 1 is a schematic diagram illustrating a method for learning in a trustless environment, according to some embodiments of the present disclosure;

FIG. 2 is a schematic illustration of a system for learning in a trustless environment, according to some embodiments of the present disclosure;

FIG. 3 is a schematic flowchart illustrating a method for repetitive self-learning, according to some embodiments of the present disclosure; and

FIG. 4 is a schematic diagram illustrating the performance levels achieved in some embodiments of the present disclosure.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or Hue perspective. For convenience or clarity, some elements or structures are not shown or shown only partially and/or with different perspective or from different point of views.

### DETAILED DESCRIPTION

Some embodiments of the present disclosure provide a system and method that enables machine learning in a trustless environment. Throughout the present description, a trustless environment is an environment where a client communicates data to a processor, but a local user of the processor cannot view the data. For example, the user cannot view the data because the data is private, confidential, and/or the user is not authorized to view the data for any other suitable reason. Accordingly, it will be appreciated that the terms “private data” or “private dataset” throughout the present description mean data that cannot be viewed and/or annotated by a user of the processor.

For example, besides the client that controls/provides the private data, and besides a learner engine executed by the provided system, the private data cannot be viewed and/or annotated by any other user of the system. For example, the private data cannot be manually annotated via a user interface of the processor.

Regularly, neural network analysis requires a large amount of pre-tagged data, as training material. However, in a trustless environment there is not enough annotated data and manual tagging is not possible. Without sufficient amount of tagged data, the training of the neural network will be flawed. Therefore, training based on private unannotated data is a real problem in the field of machine learning. Some embodiments of the present disclosure provide a solution to this problem.

The system provided by some embodiments of the present disclosure learns automatically based on un-annotated private data, without having the assistance of a user that can review and identify attributes of the data. For example, a client having a private dataset may want to use the provided system without sharing his/her confidential data with a user of the system, and without annotating by his/herself the large amount of data usually required for machine learning.

According to some embodiments of the present disclosure, the provided system extracts data representation from the private data. The data representation may include characterizing attributes of data, for example without exposing confidential aspects of the data. For example, a facial image of a person that has a certain disease may be represented by the facial attributes extracted from this image. The attributes may be characteristic of this disease, while not enabling recognition of the person or reconstruction of the same image. The extracted attributes may be used as parameters for initiation and/or updating of the learner engine, for example a learner engine trained for recognizing diseased people based on their facial features.

According to some embodiments of the present disclosure, the provided system performs data generation to generate and/or synthesize, for example based on the extracted characterizing attributes of the received private data, more data with similar characteristics. For example, the provided system may extract from private image data characterizing attributes of the data that enable the provided system to generate more synthesized images with similar attributes. By the additional data, the provided system may update and/or train its learner engine. In some embodiments, the synthesized data can be provided to a user that can add annotations to the synthesized data, while keeping the privacy of the private data, and the system can use the annotated synthesized data for training the engine.

In some embodiments of the present disclosure, the provided system may perform inference of attributes and annotate the private data by the inference process, and then train the learner engine based on the inferred annotations and data.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

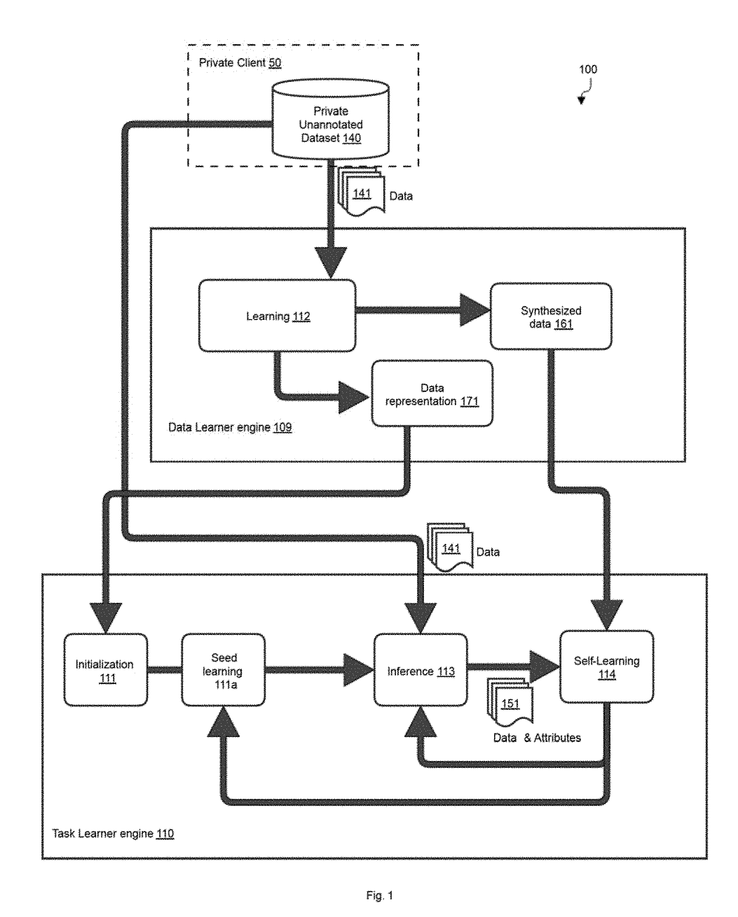

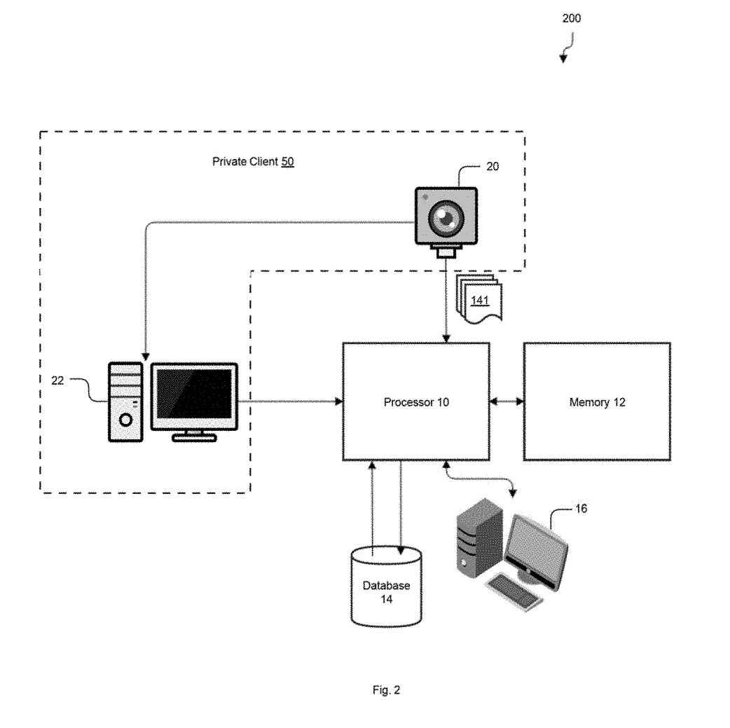

Reference is now made to FIG. 1, which is a schematic diagram illustrating a method 100 of repetitive self-learning, according to some embodiments of the present disclosure. Further reference is made to FIG. 2, which is a schematic illustration of a system 200 for repetitive self-learning, according to some embodiments of the present disclosure.

System 200 may include at least one hardware processor 10, a hardware memory 12, a database 14, and a user interface 16. System 200 may communicate with various devices 20 and 22 of a client 50 and/or located at private premises of a client 50. Processor 10 may be configured to execute method 100 according to instructions stored in memory 12. For example, memory 12 is a non-transitory memory storing code instructions executable by processor 10. When executed, the code instructions may cause processor 10 to carry out the steps of method 100 as described in detail herein. Processor 10 may execute and/or control a data learner engine 109 and/or a self-learning task learner engine 110, according to some embodiments of the present disclosure. Engines 109 and/or 110 may be configured to learn how to classify data, detect data, or any other suitable target task. For example, engines 109 and/or 110 may include machine learning capabilities, such as by neural networks.

Data learner engine 109 may be configured to receive as input unannotated private data 141, from a private dataset 140 comprising private data 141 and located at private premises of a client 50. Engine 109 may perform data learning 112, for example to generate data representation 171 and/or synthesized data 161, described in more detail herein. For example, in learning 112 engine 109 may identify attributes of unannotated private data 141, for example features and/or characteristics of private data 141, which enable generation of data representation 171 that include characteristic attributes of data 141, for example attributes necessary for performing the task of learner engine 110. Task learner engine 110 may receive as input unannotated private data 141 and learn to perform a task based on private data 141, such as a certain classification, detection or recognition task. Task learner engine 110 may be assisted by the generated data representation 171 and/or synthesized data 161. For example, data representation 171 may be used as parameters for an initialization 111 of task learner engine 110, such as for determination of initial weights and/or other parameters of task learner engine 110. Synthesized data 161 may be used as additional data for learning, as described in more detail herein.

According to some embodiment of the present disclosure, data learner engine 109 performs in learning 112 data generation to generate and/or synthesize more data, e.g. synthesized data 161. For example, engine 109 may extract from data 141 characterizing attributes of the data that enables engine 109 to generate data 161 with similar attributes. Synthesized data 161 may be used as input for self-learning 114 by task learner engine 110, described in more detail herein. For example, engine 110 may learn and/or update its parameters based on the synthesized data 161. In some embodiments of the present disclosure, the data generation is performed by unsupervised machine learning algorithms such as BEGAN, conditional GANs, DCGAN, etc., and/or image to image translation such as StarGAN, CycleGAN, UNIT, and/or any other suitable method.

For example, in some embodiments of the present disclosure, learner 110 classifies image data of a human body organ or body part, for example a human face. For example, learner 110 may have instructions to identify a disease that some of its symptoms are reflected in special characteristic facial features. Processor 10 may receive private unannotated image data 141, which cannot be viewed and/or annotated by a user of processor 10. Then, processor 10 may recognize the characteristic facial features in data 141 by an unsupervised learning algorithm and may synthesize more images, i.e. synthesized data 161, which have similar characteristics. The synthesized images may be used by processor 10 to update parameters of learner engine 110, to make the identification of the disease based on image data more accurate. For example, by training engine 110 based on me synthesized image data 161, processor 10 may update weights of learner engine 110 computed in initialization 111. The above processes are performed without having a user of processor 10 viewing and/or annotating private image data 141.

In some embodiments, the synthesized data 161 can be provided to a user that can identify attributes and/or add annotations to the synthesized data 161 by user interface 16, while keeping the privacy of private data 141. Then, the synthesized data 161 with the added annotations can be used by learner engine 110, for example in self-learning 114.

Learner engine 110 may be configured to receive private unannotated data 141 of dataset 140. For example, processor 10 receives private data 141 of dataset 140 from device 20 and/or computer 22. For example, processor 10 receives private unannotated data 141 of dataset 140 from a data capturing device 20, such as a camera or any other suitable detector, located at private premises of client 50. Private dataset 140 and/or data 141 are unavailable and/or inaccessible to user interface 16 and/or to the user controlling user interface 16 or any other user interface of processor 10, which is unauthorized to access computer 22 and/or device 20. For example, device 20 and/or computer 22 are inaccessible for viewing or manual annotation of data, or for viewing or annotation of data by user interface 16 or any other user interface of processor 10.

Some embodiments of the present disclosure provide a solution for training learner engine 110 based on unannotated private data 141, which is inaccessible for annotation by user interface 16, and/or training learner engine 110 based on unannotated private data 141, with or without receiving any kind of annotated data. For example, a client 50 controlling private dataset 140 may want to use the services of processor 10 and learner engine 110 without sharing their private and/or confidential data with a user of processor 10. Therefore, a user of processor 10 may be unauthorized and/or unable lo view and/or annotate the data of the client 50, e.g. data 141. In some embodiments, private data 141 may include interpretable and meaningful representations, such as characteristic attributes, of some full data and not the full data itself. For example, instead of receiving private images as private data 141, processor 10 may receive as data 141 interpretable and meaningful representations corresponding to private images and not the private images themselves.

Engine 110 may be configured to perform an initialization 111, e.g. determine initial weights and other parameters of task learner engine 110, for example based on some available annotated data and/or data representations 171. In some embodiments, synthesized data 161 may be viewed and/or annotated by a user and the annotated data may be used as input for initial learning of engine 110 and/or for self-learning 114, for example in case the synthesized data 161 does not include confidential information.

Engine 110 may be configured to perform inference 113, e.g., allocation of attributes 151 to private unannotated data 141, for example by inference based on initialization/initial learning 111. Processor 10 may perform inference 113 based on a current performance state of engine 110, for example after a stage of initial learning 111 and/or an intermediate stage of seed learning 111a, described in more detail herein. In some embodiments, processor 10 may perform inference 113 by another engine or by a combination of engines trained for the same or a similar target task. Then, engine 110 may perform self-learning 114, for example repetitively, based on data 141 and its attributes 151, and possibly based on synthesized data 161, as describe in more detail herein, to improve the performance of task learner engine 110.

In self-learning 114, processor 10 may fine-tune engine 110 with data 141 and its new attributes 151, and possibly synthesized data 161. The annotation of data 141 in inference 113 might be with some potential error, i.e. inaccurate annotations might be assigned to part of the data 141. It is well-known that noisy, i.e. inaccurate, annotations might deteriorate the performance of any learner engine. According to some embodiments of the present disclosure, processor 10 corrects, neutralizes or reduces the effect of inaccurate inferred attributes, such as noisy annotations, without providing access to the content of data 141 via user interface 16 or any other user interface of processor 10, to make the learner engine more resilient to errors, while keeping the data private. Since some embodiments of the present disclosure deals with inaccessible private data, the ability to correct, neutralize or reduce the effect of annotation errors without accessing the data content itself is an essential solution provided by some embodiments of the present disclosure.

Self-learning 114 may include multiple repeating stages, which may be unlimited or limited by a target quality and/or quantity value. As illustrated in FIG. 1, repeating self-learning 114 may include, at any stage, and returning to a seed learning 111a, for fine-tuning with additional data, and/or to inference 113, and then repeating self-learning 114. For example, a repetitive process continues until convergence or until a required performance level is achieved.

In some embodiments, engine 110 may be configured to receive as input some initial public data, for example data that can be viewed and/or annotated by user interface 16. Processor 10 may receive public data, for example, from database 14. Database may be a database communicating with and/or controlled by processor 10. For example, the public data is exposed to a user controlling user interface 16, which may view and allocate attributes to data by interface 16 to create annotated data. Alternatively, annotated data may be received as is from another source.

In some embodiments, engine 110 may be configured to receive as input some annotated private data. For example, computer 22 may receive some data from device 20 and enable manual annotation of the received data by an authorized entity, e.g. allocation of attributes to the data. However, the private annotated data is unavailable and/or not accessible to user interface 16 and/or to the user controlling user interface 16 or any other user interface of processor 10, which is unauthorized to access computer 22 and/or device 20. For example, device 20 and/or computer 22 are inaccessible for viewing or manual annotation of data, or for viewing or annotation of data by user interface 16 or any other user interlace of processor 10. In some embodiments, private data is located in another database(s) or source(s) and received from these other database(s) or source(s).

In some embodiments of the present disclosure, processor 10 performs supplemental intermediate learning stage 111a, for example learning by transfer learning and/or fine-tuning, herein referred to as seed learning, for example. In some embodiments, processor 10 performs initial learning 111 based on public data of a task domain unrelated to the target task. Engine 110 may be configured to perform supplemental seed learning 111a by transfer learning, for example with weights computed in initial learning 111. In some embodiments, processor 10 performs initial learning 111 based on public data of a task domain related to the target task of engine 110. Engine 110 may be configured to perform supplemental seed learning 111a by fine-tuning the weights of engine 110, optionally according to a specific private dataset.

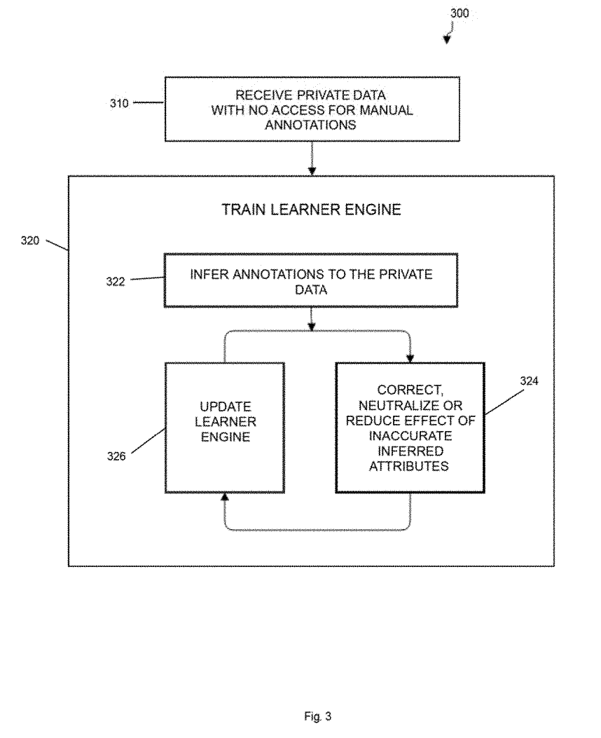

Reference is now made to FIG. 3, which is a schematic flowchart illustrating method 300 for training a learner based on private data, according to some embodiments of the present disclosure. As indicated in block 310, processor 10 may receive private unannotated data 141 from dataset 140, for example as described in detail herein, wherein private unannotated data 141 is inaccessible for manual annotations or for annotation by user interface 16 or any other user interface of processor 10. For example, private unannotated data 141 is received from a private data capturing device of client 50 inaccessible for viewing or for manual annotation of data, for example by user interface 16 or any other user interface of processor 10.

As discussed above, in some embodiments, before receiving private unannotated data 141, processor 10 receives private annotated data and updates learner engine 110 and/or data learner engine 109 based on private annotated data, wherein private annotated data is inaccessible for manual annotation by user interface 16 or any other user interface of processor 10. Further, as discussed herein, before receiving private unannotated data 141, in some embodiments processor 10 receives public annotated data and updates learner engine 110 based on public annotated data.

As indicated in block 320, processor 10 may train learner engine 110 based on unannotated private data 141. In some embodiments of the present disclosure, as indicated in block 322, processor 10 may infer attributes/annotations 151 to data 141. The inferring may be performed by learner engine 110, by another learner engine, or by multiple learners.

As indicated in block 324, processor 10 may correct, neutralize or reduce the effect of inaccurate inferred attributes. For example, processor 10 may model the noise, i.e. the inaccuracies in annotations 151, as a softmax layer of a neural network that connects annotations 151, for example with latent random variables representing the correct annotations and the corresponding features of data 141, for example with methods such as described in reference [1] or any other suitable method. Processor 10 may add the softmax layer to engine 110 and execute engine 110, thus, for example, engine 110 may learn the distribution of the inaccuracies in annotations 151, e.g. the confusion matrix of annotations 151, and, for example, may label inaccuracies in annotations 151. In another example, processor 10 may execute two instances of learner engine 110, or another learner engine besides learner engine 110, with the same inferred annotations 151 and private data 141, for example as suggested in reference [2] or by any other suitable method. Processor 10 may determine when the results generated by the two instances or the two engines are different, for example when the difference between the results exceeds a certain threshold. For example, processor 10 may determine when classifications of data 141 by the two instances of engine 110 are different between the instances or engines. In case a difference is identified between the instances or learner engines, processor 10 may update the two instances or at least learner engine 110, based on the corresponding portion of data 141 and its annotation(s) 151. Other processes for correcting, neutralizing or reducing the effect of inaccurate inferred attributes may be used and the disclosure is not limited in this respect. Moreover, several processes for correcting, neutralizing or reducing the effect of inaccurate inferred attributes may be used in combination.

As indicated in block 326, processor 10 may update learner engine 110 based on the inferred attributes and/or the correction, neutralization and/or reduction of the effect of inaccurate inference. In some embodiments, processor 10 may repeal the receiving of private unannotated data 141, inferring of attributes/annotations 151, and/or the updating of engine 110. It will be appreciated that the correction, neutralization or reduction of the effect of inaccurate inferred attributes can be performed in some embodiments during the update of the learner engine, and vice versa.

The performance of learner engine 110 highly depends on the type of the noise and its level in the training data. Therefore, in order to maintain a required performance level of engine 110, in some embodiments of the present disclosure, processor 10 may estimate the potential noise generated in inference 113. Based on this estimation, processor 10 may determine the amount of new data 141 and corresponding annotations 151 that should be acquired and/or used in the self-learning stage 114.

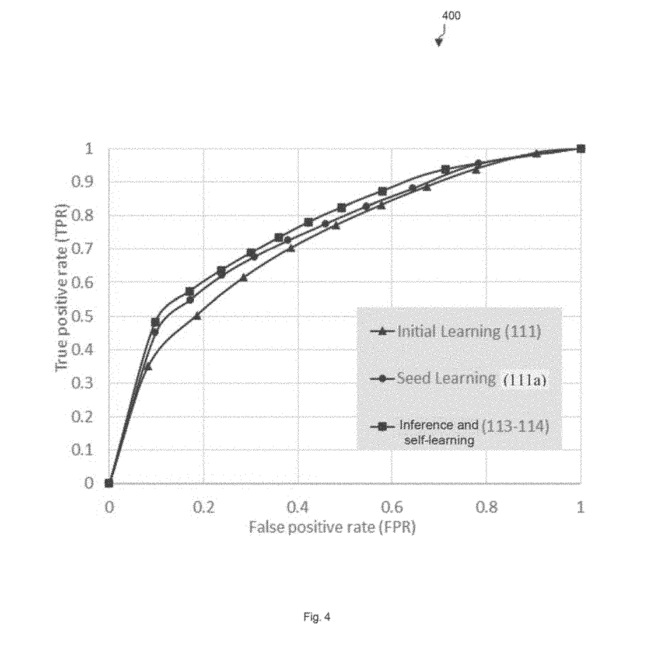

Reference is now made to FIG. 4, which is a schematic diagram 400 illustrating the performance levels achieved in some embodiments of the present disclosure, where the learner engine 110 is a binary classifier, the data are 2D images and their annotated attributes are labels specifying whether a person appears in the image or not. Diagram 400 shows the performance of the classifier after initial learning 111 (shown by the line marked with triangles), after seed learning 111a (shown by the line marked with circles) and after inference and self-learning stages 113 and 114 (shown by the line marked with squares). The performance levels of the three states of the classifier are presented in diagram 400 by receiver operating characteristic (ROC) curves that plot the true positive rate (TPR) versus the false positive rate (FPR) for varying discrimination thresholds. The base classifier was initially trained in initial learning 111 on an exemplary public annotated data containing about 250,000 images and their true labels taken from datasets such as COCO [3], PascalVOC [4] and PIROPO [5] (an exemplary public dataset). It was then fine-tuned in seed learning stage 111a with exemplary private annotated data of 250,000 manually labeled images, retrieved from the non-confidential YiHome camera dataset (an exemplary private annotated dataset). The line marked with circles shows a ROC curve of a finer version of the classifier, where its initial weight values were retrieved from the base classifier on initialization. The second fine-tuning was performed on additional 200,000 unlabeled images taken from the confidential YiHome camera dataset (an exemplary unannotated dataset). The second fine-tuning is a two-tier process. Specifically, an inference stage 113 was first applied on the unlabeled confidential images using the base classifier. Then, the classifier was fine-tuned with new auto-labeled images at the self-learning stage (stage 114). As shown in FIG. 4, the performance of each fine-tuned classifier is higher than its base classifier. This demonstrates the ability of the framework to improve the performance of a learner using ongoing training on new unlabeled data.

Some embodiments of the present disclosure may include a system, a method, and/or a computer program product. The computer program product may include a tangible non-transitory computer readable storage medium (or media) having computer readable program instructions thereon for causing a processor to carry out aspects of the present disclosure. Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including any object oriented programming language and/or conventional procedural programming languages.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor, or a portable device such as a smart phone or a tablet computer, or a micro-processor, or a RISC processor, or a DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or electronic circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry. The processor and program may constitute the same apparatus, at least partially, such as an array of electronic gates, such as FPGA or ASIC, designed to perform a programmed sequence of operations, optionally comprising or linked with a processor or other circuitry.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing (lie specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless Otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method for training a learner based on private data, the method comprising:
receiving by a processor private unannotated data from a private unannotated dataset, the private unannotated data is inaccessible by a user interface of the processor; and
training a learner engine based on the received private data.

2. The method of claim 1, comprising inferring attributes to the received private unannotated data, and updating the learner engine based on the inferred attributes.

3. The method of claim 2, wherein the inferring is by the learner engine.

4. The method of claim 2, wherein the inferring is by at least one other learner engine.

5. The method of claim 2, comprising repeating the receiving of private unannotated data, inferring, and updating.

6. The method of claim 2, comprising correcting, neutralizing or reducing the effect of inaccurate inferred attributes.

7. The method of claim 1, comprising, before receiving of private unannotated data, receiving private annotated data and updating the learner engine based on the received private annotated data, wherein the received private annotated data is inaccessible by the user interface of the processor.

8. The method of claim 7, wherein the repeating includes repeating the receiving of the private annotated data and updating the learner engine based on the received private annotated data.

9. The method of claim 1, comprising, before receiving of private unannotated data, receiving public annotated data and updating the learner engine based on the received public annotated data.

10. The method of claim 9, wherein the repeating includes repeating the receiving of the public annotated data and updating the learner engine based on the received public annotated data.

11. The method of claim 1, wherein the private unannotated data is received from a private data capturing device inaccessible for viewing or annotation of data by the user interface of the processor.

12. The method of claim 7, wherein the private annotated data is received from a private computer inaccessible for viewing or annotation of data by the user interface of the processor.

13. The method of claim 1, comprising estimating, by the processor, the potential noise generated in the inference of annotations, and determining, based on the estimation, the amount of new private unannotated data and corresponding inferred annotations that should be acquired.

14. The method of claim 1, comprising generating synthesized image data and training the learner engine based on the synthesized image data.

15. A system for training a learner based on private data, the system comprising:
a processor;
a user interface for communicating with the processor, and
a private dataset inaccessible for viewing or annotation of data by the user interface of the processor,
wherein the processor is configured to execute code instructions that cause the processor to:
receive private unannotated data from the private dataset, the private unannotated data is inaccessible by the user interface of the processor; and
train a learner engine based on the received private data.

16. The system of claim 15, wherein the code instructions cause the processor to infer attributes to the received private unannotated data, and to update the learner engine based on the inferred attributes.

17. The system of claim 16, wherein the inferring is by the learner engine.

18. The system of claim 16, wherein the inferring is by at least one other learner engine.

19. The system of claim 16, comprising repeating the receiving of private unannotated data, inferring, and updating.

20. The system of claim 16, comprising correcting, neutralizing or reducing the effect of inaccurate inferred attributes.

21. The system of claim 15, wherein the code instructions cause the processor to estimate the potential noise generated in the inference of annotations, and determine, based on the estimation, the amount of new private unannotated data and corresponding inferred annotations that should be acquired.
